(19) United States
(12) Patent Application Publication
(10) Pub. No.: US 2003/0051135 A1
(43) Pub. Date: Mar. 13, 2003

(54) Protecting data in a network attached storage device

(76) Inventors: Michael Gill, Spring, TX (US); Michael F. Angelo, Houston, TX (US)

Correspondence Address: CONLEY ROSE, P.C., P. O. BOX 3267, HOUSTON, TX, 77253-3267, US

(21) Appl. No.: 09/943,822

(22) Filed: Aug. 31, 2001

(51) Int. Cl. H04L 9/00

(52) U.S. Cl. 713/160

(57) ABSTRACT

A computer system comprises at least one computer and at least one storage device coupled together via a network. The computers can store data on and read data from network storage devices. Preferably, the computers encrypt data as part of the transmission protocol. The encrypted data is then sent to the storage device where the packets are parsed and the encrypted data is stored in its encrypted form. When a computer requests data that is stored on the storage device, the storage device retrieves the requested data (which is encrypted) and transmits the encrypted data to the computer that requested the data. The computer then decrypts the encrypted data to recover the original data. Alternatively, the storage device again encrypts the already encrypted data when sending the data back to the requesting computer. The twice encrypted data is then received by the computer and twice decrypted to recover the original data.

### STATEMENT REGARDING FEDERALLY SPONSORED RESEARCH OR DEVELOPMENT

Not applicable.

### CROSS-REFERENCE TO RELATED APPLICATIONS

Not applicable.

### BACKGROUND OF THE INVENTION

1. Field of the Invention

The present invention relates generally to security on a computer network. More particularly, the invention relates to protecting data stored on a network attached storage device. Still more particularly, the invention relates to storing data in encrypted form on a network attached storage device and reducing performance impact.

2. Background of the Invention

Security is a concern for many computer systems, particularly those computer systems that contain sensitive information. In some applications, a storage device is coupled to a network and accessible by various computers also coupled to the network. Such storage devices are referred to as network attached storage (“NAS”) devices. A security issue arises in the context of a network to which unrelated entities have access. If such a network includes a NAS device to which each entity can access, a security system should be implemented to prevent one entity from accessing the data stored on the NAS by an unrelated entity.

In one type conventional security systems, each entity wishing to store data on the NAS encrypts the data and transmits the encrypted data to the NAS device. Upon receipt of the encrypted data, the NAS device decrypts the data and stores the decrypted data on the device. This security system minimizes the risk that an unauthorized entity can intercept a transmission and recover the data in a useful form. Because the transmission includes encrypted data, the unauthorized entity will find the data unless it knows or figures out how to decrypt the message.

Although generally satisfactory, this approach is not without its shortcomings and limitations. For instance, once the NAS successfully decrypts the data and stores it therein, the unencrypted data can be accessed by unauthorized entities.

Further still, encryption typically involves a pair of “keys.” The data may be encrypted with a “public” key by the entity transmitting the data and then decrypted by the NAS device using a related “private” key. The public-private key pair is unique to each entity. That is, each entity has a public-private key pair that is different from the key pairs of the other entities. As its name implies, the private key is highly confidential and protecting the security of the private key itself is of paramount concern. If the private keys were stored on the NAS, a security problem would arise if unauthorized entities were to obtain the private keys. With the private keys in the hands of an unauthorized entity, any confidential data transmitted to the NAS may be compromised. Various security protocols have been suggested and implemented to deal with this concern, but no security system is 100% fool proof.

Another shortcoming is that the NAS device must incur the task of decrypting the incoming data to extract the original unencrypted data. This task takes time and processing power that perhaps could be used to do other tasks. At a minimum, a NAS that does not have to perform the decryption task would be faster and thus less expensive. Accordingly, a security mechanism is needed which addresses these issues.

### BRIEF SUMMARY OF THE INVENTION

The problems noted above are solved in large part by a computer system comprising at least one computer and at least one storage device coupled together via a network. The computers can store data on and read data from the storage devices. Preferably, the computers transmit data and encrypt the payload as part of the transmission process. This entire packet is transmitted to the storage device where the packet is received, and the encrypted payload is stored still in encrypted form. When a computer requests data that is stored on the storage device, the storage device retrieves the requested data (which is encrypted) and transmits the still encrypted data to the computer that requested the data. The requesting computer then decrypts the encrypted data and recovers the original data.

In an alternative embodiment, the storage device again encrypts the already encrypted data when sending the data back to the computer. The twice encrypted data is then received by the requesting computer and twice decrypted to recover the original data. Further still, digital signatures can be implemented to help verify the origin, authenticity, and integrity of the data.

By storing encrypted data on the storage device, without first decrypting it, no encryption/decryption keys need be stored on the storage device. Accordingly, security is increased by not having the data stored in an unprotected manner on the storage device. Further, the storage device need not incur the resource overhead associated with decrypting data. These and other advantages will become apparent upon reviewing the following disclosure.

### BRIEF DESCRIPTION OF THE DRAWINGS

For a detailed description of the preferred embodiments of the invention, reference will now be made to the accompanying drawings in which:

FIG. 1 shows a block diagram of a computer system including computers and a network attached storage device coupled together via a network;

FIG. 2 shows an exemplary data packet format used to transmit data packets across the network;

FIG. 3 shows one preferred embodiment for transmitting encrypted data from a computer to the storage device where the data is stored in its encrypted form; and

FIG. 4 shows an alternative embodiment in which data is twice encrypted when being sent from the storage device to the computer requesting the data.

### NOTATION AND NOMENCLATURE

Certain terms are used throughout the following description and claims to refer to particular system components. As one skilled in the art will appreciate, computer companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. To the extent that any term is not specially defined in this specification, the intent is that the term is to be given its plain and ordinary meaning.

### DETAILED DESCRIPTION OF THE PREFERRED EMBODIMENTS

In general, the preferred embodiments of the invention described below involve transmitting encrypted data to a network attached storage (“NAS”) device and storing the data in the NAS device in encrypted form, rather than decrypting it before storage therein. The following embodiments describe several variations on this theme.

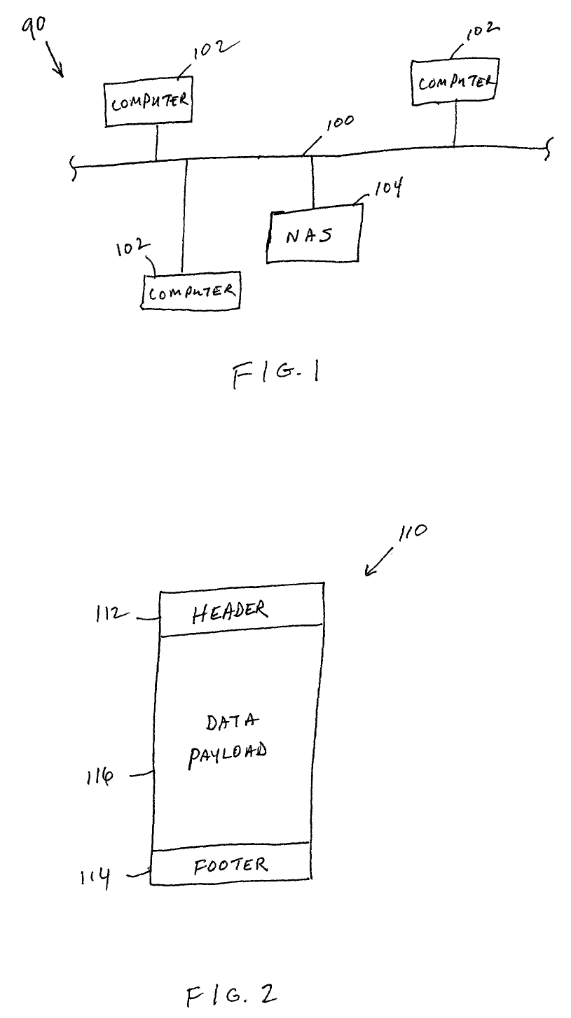

Referring first to FIG. 1, a computer system 90 is shown as comprising one or more computers 102 and a NAS 104 coupled together via a network link 100. The system 90 may comprise a local area network (“LAN”), a wide area network (“WAN”), such as the Internet, and, in general, include any type of communication infrastructure through which computers 102 and NAS 104 can communicate with one another. Preferably, each computer 102 can write data to and/or read data from NAS 104 over the network link 100. The computers 102 can be any suitable type of computer, workstation, mainframe, or, in general any entity that can access a storage device in a network. The NAS 104 is any suitable type of mass storage device such as a hard disk drive, R/W CD ROM, tape drive, etc, and thus includes some form of a non-volatile storage medium on which data can be stored. The NAS 104 includes logic (not shown), which may be implemented in a network interface card (“NIC”) logic or in software executed by a processor contained in the NAS that performs the functions described herein. The functions described below attributable to the computers 102 also may be implemented in a NIC (not specifically shown) that preferably is included in each computer for communicating over the network link 100. However, one of ordinary skill in the art will understand that there are many ways to implement the functionality described herein (e.g., hardware, software, a combination of hardware and software) and the claims which follow should not be limited to any particular implementation.

Data is transmitted over the network link 100 preferably in the form of packets such as that shown in FIG. 2. As shown, packet 110 includes a header portion 112, a footer portion 114, and a data payload 116. As is well known in the art, the header contains information (e.g., IP address, routing information, etc.) that permits the network 100 to determine how to route the packet from the source to the destination. The footer contains information that indicates the end of the packet. The header and/or footer may also contain cryptographic integrity/authenticity metrics (ala a digital signature) and are used to validate the integrity/authenticity of the data prior to storing the encrypted data on the storage device. These metrics preferably are secure hashes and digital signatures. The data payload 116 contains the data, which may include, data, commands or any type of information, to be transmitted between computers 102 and NAS 104.

In accordance with the preferred embodiment, when a computer 102 uses the network link 100 to transmit to the NAS 104 a packet 110 containing a data payload 116, the data payload preferably is encrypted. Any suitable encryption algorithm now known or later developed can be used such as “DES”, “AES”, “Blowfish,” and the like. In addition any suitable networking protocol now known or later developed can be used such as “IPSEC” or “SSL.” While the specific examples given in this disclosure are of the current commonly used asymmetric cipher or public-key/private-key algorithm type, nothing precludes the embodiment being realized using a symmetric cipher or secret-key algorithm. The data, in encrypted form, is stored in the NAS's non-volatile memory. In contrast to conventional storage techniques, the data is not decrypted before being stored on the NAS.

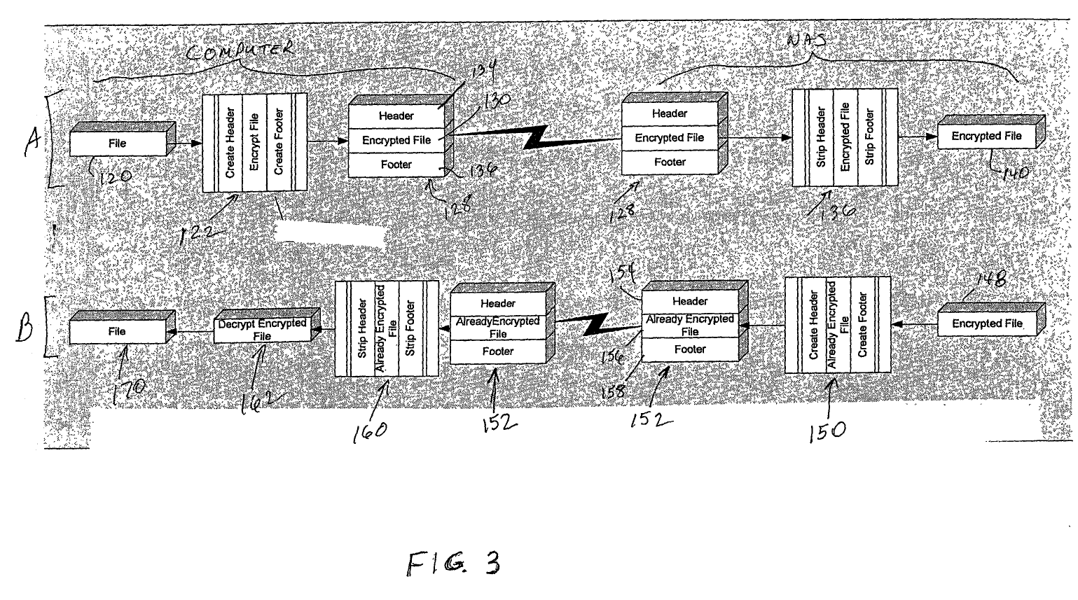

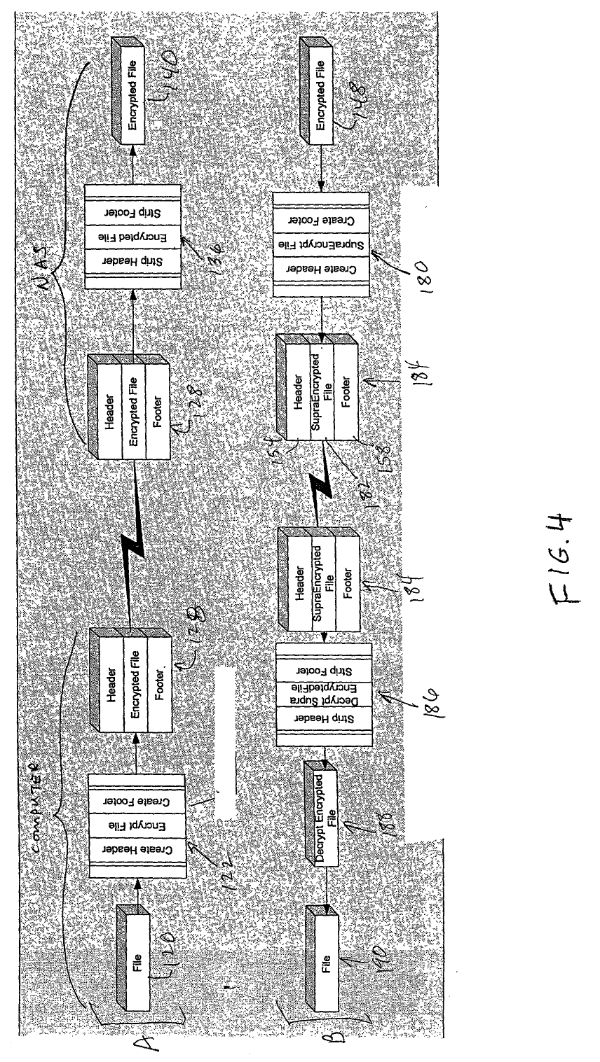

FIGS. 3, and 4 illustrate variations on this preferred technique in which encrypted data is stored on the NAS 104, rather than unencrypted data. FIGS. 3 and 4 illustrate the process flow for how data is encrypted by a computer, transmitted to a NAS, stored on the NAS and how NAS data is retrieved and provided to the computer. Each figure shows two communication paths—A and B. The A path in each figure shows the process for sending data from a computer to the NAS 104 for storage therein, while the B path shows the process for retrieving data from storage in the NAS and transmitting it to the computer.

Referring first to FIG. 3, a data file 120 (which may also be a data stream, a block of data or other type of data unit) is turned into a data packet 128 by steps 122. As such, a header 132 and a footer 134 are created. The payload is encrypted preferably using the user's public key (although a secret key can also be used) to form an encrypted data payload 130 and the header 134, encrypted data payload 130 and footer 136 are assembled together into a packet 128 as noted above with regard to FIG. 2. The key used to encrypt the file 120 may be stored in the computer or otherwise accessible to it.

That packet 128 containing encrypted data is transferred across network link 100 to NAS 104 where the header and footer are stripped off and the encrypted data payload is obtained and stored as encrypted data 140 on NAS 104. Data that is stored on NAS 104 in encrypted form obviously eliminates the NAS 104 from having to decrypt the data as is required in some conventional systems. Thus, no decryption keys are necessary and no keys need be stored on NAS 104.

In the B path, in which data flows from the NAS to a computer requesting the data, an encrypted data file 148 is turned into a packet 152 (steps 150) by NAS 104. In accordance with these steps, a header 154 and a footer 158 are created to permit the network link 100 to route the packet to a destination computer 102. The already encrypted data file 148, which is retrieved from non-volatile memory in the NAS, is included in the packet 152 as encrypted data payload 156 as shown. The packet 152 is then transmitted across the network link 100 to the destination computer where steps 160 are applied by the computer to strip off the header and footer to recover the encrypted data file. The encrypted file is then decrypted by the computer 102 in step 162 using a private key (or public key if a private key was used to encrypt the data initially) to transform the data into its unencrypted format. Thus, both the encryption and decryption processes are performed by the source of the data (i.e., the computers 102), not the NAS 104, and, accordingly, both the public and private keys used in the encryption/decryption process are stored on, or are accessible to, the computer 102.

An alternative embodiment is shown in FIG. 4. The process in path A for encrypting the data file, creating the data packet, transmitting the packet across the network, retrieving the encrypted data payload in the packet and storing the data in encrypted form on the NAS is the same as described above with regard to FIG. 3. The difference in FIG. 4 pertains to path B when a computer 102 accesses encrypted data from NAS 104. In that regard, the encrypted file 148 to be transmitted to the requesting computer 102 is processed by steps 180 by which a packet 184 is created. The packet 184 includes a header 154 and footer 158 as before, but the encrypted data file 148 is encrypted again (this time by the NAS) to produce a “supra-encrypted” data payload 182 (i.e., twice encrypted data). The packet 184 then is transferred from the NAS 104 to the destination computer 102. In steps 186, the computer 102 strips off the head and footer, decrypts the supra-encrypted data payload to recover the originally encrypted file 148. The encrypted file 148 is then decrypted again in 188 to recover the original unencrypted data file 190. Thus, in the embodiment of FIG. 4, the computer twice decrypts the data received from the NAS 104.

In the embodiment of FIG. 4, the encrypted file 148 can be supra-encrypted using a public key associated with the destination computer or the entity or person owning or operating the computer. The private key necessary to decrypt the supra-encrypted data payload in step 186 is stored on or is accessible to the computer 102. As such, one key is stored on, or accessible to, the NAS 104 and the corresponding other key is stored on, or accessible to, the computer 102. Requiring a private key to decrypt the supra-encrypted data advantageously makes it difficult, if not impossible, for an unauthorized person (not having the private key) to intercept and access the data. The public/private keys used to encrypt the file 120 and decrypt the decrypted supra-encrypted file in step 188 preferably are both stored on or accessible to the computer 102 and preferably are different than the keys used to create the supra-encrypted data payload in 180 and decrypt the supra-encrypted data in 186 (although they can be the same if desired).

In addition, a digital signature can be applied to the packets as they are transmitted from the computer across the network 100 to the NAS 104. The digital signature, which can be applied in accordance with any well-known or later developed techniques, are then used by NAS 104 to verify the authenticity of the packet (i.e., that the packet indeed did originate from a certain computer 102).

One last embodiment would handle the case in which the networking protocol uses a predetermined or dynamically generated session key. If dynamically generated, the session key can be negotiated in any suitable manner between the computer and NAS. In this case the session key (K_{S}) could be stored on the requestor's machine and associated with the file being sent to the NAS. When the requestor asked for the file back, the key (Kₛ) could be looked up in the requestor's database. This key would then be used to decrypt the file. The decryption could take place either after it was transferred, or during the transferal.

The above discussion is meant to be illustrative of the principles and various embodiments of the present invention. Numerous variations and modifications will become apparent to those skilled in the art once the above disclosure is fully appreciated. For example, although the embodiments described above have been presented in the context of a network attached storage device coupled to a computer network, in general, the principles apply to the transfer from one point to another of any type of data across any type of network. It is intended that the following claims be interpreted to embrace all such variations and modifications.

What is claimed is:

1. A method of transferring data between a computer and a non-volatile storage device, both said computer and said storage device coupled to a network, comprising:
(a) encrypting the data;
(b) transmitting the encrypted data across a network to the storage device; and
(c) storing the encrypted data on the storage device.

2. The method of claim 1 wherein (b) also includes creating a header containing destination information pertaining to the storage device and transmitting the encrypted data in conjunction with the header.

3. The method of claim 2 wherein the header or footer contains cryptographic metrics on the data.

4. The method of claim 2 wherein (c) includes removing the header before storing the encrypted data on the storage device.

5. The method of claim 4 wherein the header or footer contains cryptographic metrics for the data and using said metrics to validate the integrity/authenticity of the data prior to storing the encrypted data on the storage device.

6. The method of claim 1 further including retrieving the encrypted data from the storage device and transmitting said encrypted data to the computer.

7. The method of claim 6 further including receiving the encrypted data at the computer and decrypting the encrypted data received by the computer.

8. The method of claim 6 further including transmitting said encrypted data to the computer with a header that provides routing information pertaining to the computer.

9. The method of claim 1 further including retrieving the encrypted data from the storage device, encrypting the encrypted data with a pre-determined key, and transmitting the twice encrypted data to the computer.

10. The method of claim 9 further including twice decrypting the twice encrypted data received by the computer.

11. A method of transferring data between a computer and a nonvolatile storage device, both said computer and said storage device coupled to a network, comprising:
(a) retrieving encrypted data from the storage device;
(b) transmitting the encrypted data across a network from the storage device to the computer; and
(c) receiving the encrypted data at the computer;
(d) decrypting the encrypted data received in (c).

12. The method of claim 11 wherein (b) also includes creating a header containing destination information pertaining to the computer and transmitting the encrypted data in conjunction with the header.

13. The method of claim 11 further including removing the header before decrypting the encrypted data received in (c).

14. The method of claim 11 further including:
(e) encrypting data by a computer;
(f) transmitting the encrypted data from the computer across a network to the storage device; and
(g) storing the encrypted data on the storage device.

15. The method of claim 14 wherein (f) also includes creating a header containing destination information pertaining to the storage device and transmitting the encrypted data in conjunction with the header.

16. The method of claim 15 wherein (g) includes removing the header before storing the encrypted data on the storage device.

17. The method of claim 1 1 further including encrypting the encrypted data retrieved from the storage device in (a) and, in (b) transmitting the twice encrypted data across the network to the computer, and in (c) receiving the twice encrypted data.

18. The method of claim 17 wherein (d) includes twice decrypting the twice encrypted data received in (c).

19. A computer system, comprising:
a computer; and
a nonvolatile storage device external to said computer and coupled to said computer over a network;
wherein said computer sends encrypted data to said storage device over said network and said storage device stores the data in encrypted form.

20. The computer system of claim 19 wherein said computer sends said encrypted data to said storage device with a header that contains destination information pertaining to the storage device.

21. The computer system of claim 20 wherein said storage device removes the header before storing the encrypted data.

22. The computer system of claim 20 wherein said storage device retrieves encrypted data from storage and transmits said encrypted data to the computer over the network.

23. The computer system of claim 22 wherein said computer receives the encrypted data at the computer from the storage device and said computer decrypts the encrypted data.

24. The computer system of claim 22 wherein said storage device transmits said encrypted with a header that provides routing information pertaining to the computer.

25. The computer system of claim 20 wherein said storage device retrieves encrypted data from storage therein, encrypts said encrypted data and transmits the twice encrypted data to the computer.

26. The computer system of claim 25 wherein said computer twice decrypts the twice encrypted data transmitted to the computer by the storage device.

27. A computer system, comprising:
a computer; and
a nonvolatile storage device external to said computer and coupled to said computer over a network;
wherein said storage device retrieves encrypted data stored therein, transmits the encrypted data across the network to said computer where in the computer receives and decrypts the encrypted data.

28. The computer system of claim 27 wherein said storage device creates a header containing destination information pertaining to the computer and transmits the encrypted data with the header to the computer.

29. The computer system of claim 28 wherein said computer removes the header before decrypting the encrypted data received from the storage device.

30. The computer system of claim 27 wherein said computer encrypts data and transmits said encrypted data to said storage device where said encrypted data is stored.

31. The computer system of claim 30 wherein said computer creates a header containing destination information pertaining to the storage device and transmits the encrypted data with the header to the storage device.

32. The computer system of claim 31 wherein the storage device removes the header before storing the encrypted data.

33. The computer system of claim 27 wherein the encrypted data retrieved by the storage device is again encrypted and the storage device transmits the twice encrypted data across the network to the computer.

34. The computer system of claim 33 wherein the computer twice decrypts the twice encrypted data received from the storage device.

35. A method of transferring data between a computer and a non-volatile storage device, both said computer and said storage device coupled to a network, comprising:
(a) issuing a transmission command for data;
(b) encrypting the data as part of the transmission process;
(c) transmitting the encrypted data across a network to the storage device; and
(d) storing the encrypted data on the storage device.

36. The method of claim 35 wherein (a) includes encrypting the data with a dynamically generated session key.

37. The method of claim 36 further including retrieving the encrypted data from the storage device, transmitting said encrypted data to the computer, and decrypting the encrypted data using said session key.
